(19) United States
(12) Patent Application Publication
(10) Pub. No.: US 2012/0010911 A1
(43) Pub. Date: Jan. 12, 2012

(54) SYSTEMS AND METHODS FOR OPTIMIZING THE SCHEDULING OF RESOURCES ON AN AIRPLANE

(76) Inventors: Avinash S. Lele, Palo Alto, CA (US); Sanjeev R. Kulkarni, Princeton, NJ (US)

(21) Appl. No.: 12/845,939

(22) Filed: Jul. 29, 2010

Related U.S. Application Data
(63) Continuation-in-part of application No. 12/832,733, filed on Jul. 8, 2010.

(51) Int. Cl. G06Q 10/00

(52) U.S. Cl. 705/5

(57) ABSTRACT

A system and method for enabling passengers to swap seats with other passengers, so that they may obtain seats that appear to be unavailable because they are occupied. Passengers use interfaces to specify their desire and/or willingness to switch seats, including to get better seats, give up their seats for compensation, or sit together and/or sit with other passengers, and the conditions, if any, for switching. A processor runs an algorithm reassigning passenger seats based on the conditions inputted at the interface. Passengers are notified of their new seats, and may be charged or compensated for switching seats.

The instant application is a continuation-in-part application of co-pending application Ser. No. 12/832,733 filed Jul. 8, 2010.

The present disclosure is directed to systems and methods for allocating seats to customers. It is particularly useful for optimizing the reassignment of seats on airplanes or in other contexts where seats are preassigned.

### BACKGROUND

Seating arrangements in various venues present logistical problems related to the allocation of the seats to potential customers. Customers may have individual preferences and there may be a finite number of seats having a specific set of attributes. For example, some football fans desire to sit at the 50 yard line while others prefer end zone seats. Additional logistical problems may be encountered if seats are controlled by different entities such as the stadium owner and ticketing and brokering service providers.

The present disclosure is directed to systems and methods for allocating seats that take into account the preferences of the customers when seats that satisfy those preferences are preassigned to other customers. Although the teachings of the present disclosure are applicable to any context in which seats are allocated to customers, the present disclosure is described with respect to the allocation of seats on an airline flight as an example of the teachings and principles presented herein.

Many airline passengers care about which seat they sit in when they fly. A seat may have many different attributes including type of seat (aisle, middle, window, etc.), location on the plane (front, back, left, right, exit row, center section on a wide body jet, seats in the smoking section, etc.), class of service (first, business, economy, etc.), and other attributes. Many business travelers, for example, prefer aisle seats while children often want window seats so they can look out the window. On overnight flights, some people want aisle seats to avoid feeling trapped by their seatmate, while others want a window to lean against. Conversely, there are seats that many passengers do not want. Middle seats are a good example, because they do not offer the benefits of aisle seats or window seats and also make the passenger feel cramped. Bulkhead seats are another example of seats that some people try to avoid but that others prefer for the extra legroom.

In addition to type of seat, passengers' seating preferences may be based on location. For example, some people prefer sitting near the front of the plane to be able to make a quick exit when the plane lands, while others prefer seats in the back to qualify for an earlier boarding group. Some people even have a preference as to the left or right side of the plane. Conversely, some passengers do not like seats in the last row, given their typical proximity to the lavatories. Passengers also sometimes try to avoid seats in front of an exit row if they do not recline.

Also, passengers travelling in a group often want to sit together. For instance, it can be highly inconvenient for a family with small children to have to sit in seats that are scattered about the plane. Or, business colleagues may want to sit together to be able to talk and make productive use of their time in the air. It can be challenging to find seats that are together if the tickets are purchased close to the departure date when many seats on the flight have already been assigned to other passengers, or when the members of a group are not all in the same airline record. Passenger seating preferences thus may include preferences as to type of seat, location of seat, and who the passenger would like to sit with.

Seating preferences can be so important to people that a number of services have been introduced in recent years to aid passengers in selecting their specific seats. Airline and third party services (e.g., Travelocity, Expedia) permit passengers to view a seat map and choose their specific seats online. Indeed, passengers are often given the opportunity to view what seats are available before they buy their tickets, making it possible to take seat availability into account when deciding on a flight. Self-service check-in kiosks at the airport also enable a passenger to view his seat, see what other seats are not occupied, and switch to an unoccupied seat if desired. Passengers can also intelligently choose seats using third party services like seatguru.com, seatmaestro.com, and seatexpert.com to get information about the seating configuration of, and attributes and ratings of seats on, the flight the passenger is taking or thinking of taking.

These services and others make it easier and more convenient for passengers to choose seats they want, but they have their limitations. For example, the only seats that a passenger can choose are those that are not already preassigned to another passenger. On relatively full flights, this usually means that the only seats that are available for a passenger to choose from are the least desirable ones (e.g., middle seats, seats in the last row of the plane). This also makes it difficult for passengers to find seats that are together.

There is a need for a system and method for allocating seats to accommodate passenger seating preferences even on a plane that is full or nearly full, where passengers are willing to swap seats with one another. One example is a full plane where one passenger has an aisle seat but wants a window seat, and another passenger has a window seat but wants an aisle seat. Another example is a full plane where a family is travelling together but has been assigned seats that are not together. Others on the plane may be willing to switch seats with members of the family. But there is currently no way for passengers to know about and take advantage of such opportunities to swap seats, leaving some passengers dissatisfied with their seating when they need not be.

The present disclosure is directed to systems and methods for enabling passengers to switch to other seats, even when the desired seats have been preassigned to other passengers, by swapping seats with other passengers. In one embodiment, a user interface is provided whereby a passenger may submit a seat reassignment request that specifies conditions under which he or she would like to trade his preassigned seat for another seat. These conditions may include seat attributes that specify the type, location, and other attributes of seats that the passenger would like to trade for, and a trade value that specifies what, if anything, the passenger is willing to give to trade seats.

In one embodiment, where a party is travelling together but does not have seats together, the user interface may allow them to specify their desire to trade their seats for other seats that are together. Passengers who are not in the same airline record but who nonetheless wish to sit together may also specify their desire to do so. A member of the party using the interface may specify the various configurations of seats that he or she deems as being “together,” e.g., seats that are next to each other, seats that are across the aisle from each other, and so on. The interface also may enable the user to specify whether sitting together in smaller groups is acceptable if it is not possible to seat everyone together. In addition, the interface may allow the user to specify any conditions that must be met by the new seats in addition to being together—e.g., that the new seats must include a window (which may be desirable if the party includes a child) or an aisle (so the party does not feel trapped in their seats). The interface thus may allow the specification of multiple conditions, including passenger seating preferences (e.g., seat attributes such as type and location of seats, as well as who the passenger(s) would like to sit with) and trade values. (This terminology—, e.g., conditions, seating preferences, seat attributes, and trade values and the hierarchy and relationships among them—applies throughout the present disclosure and not merely for this embodiment.)

In one embodiment, the user interface also may be designed to enable passenger(s) to specify their willingness to give up their preassigned seats for other seats chosen by the airline. The passengers also may specify seating preferences, including seat attributes that the new seat must satisfy for a trade to be made (e.g., that the new seat must be a window seat). The trade further may be conditioned on a trade value (e.g., an amount of money, airline miles, or some other form of compensation) that passenger(s) are willing to accept for giving up their preassigned seat. The system may be designed to enable passenger(s) to specify both a desire to trade a preassigned seat for a more desirable seat and a willingness to give up a preassigned seat for another seat chosen by the airline.

In one embodiment, the system may use a processor to compute a seat reassignment that achieves a sufficiently good or optimal value of a desired parameter (e.g., number of satisfied passengers, revenue generated by seat switches, etc.) using the passenger inputs. In this manner, the systems and methods of the invention may enable passengers to swap for seats that otherwise appear to be unavailable because they are preassigned to other passengers. Passengers may benefit by having more opportunities to get the seats they prefer or receiving remuneration for less desirable seats, and airlines may benefit by increasing passenger satisfaction and/or revenues.

### BRIEF DESCRIPTION OF THE DRAWINGS

FIG. 1 is a simplified block diagram of one embodiment of the present disclosure.

FIG. 2 illustrates one embodiment of a user interface for a solo passenger to select a seat from those that are unoccupied and switch seats if desired.

FIG. 3 illustrates one embodiment of a user interface for a solo passenger to specify conditions for a seat swap.

FIG. 4 illustrates one embodiment of a user interface for a group of passengers to select seats from those that are unoccupied and switch seats if desired.

FIG. 5 illustrates one embodiment of a user interface to submit a group seat reassignment request.

FIG. 6 illustrates one embodiment of a user interface for a solo passenger to specify potential seatmate(s).

FIG. 7 illustrates one embodiment of a user interface for a group of passengers to specify potential seatmate(s).

FIG. 8 illustrates a simplified flow diagram of one embodiment of a method for passengers to switch seats.

FIG. 9 illustrates a simplified flow diagram of one embodiment of a method for processing passenger seat reassignment requests.

### DETAILED DESCRIPTION

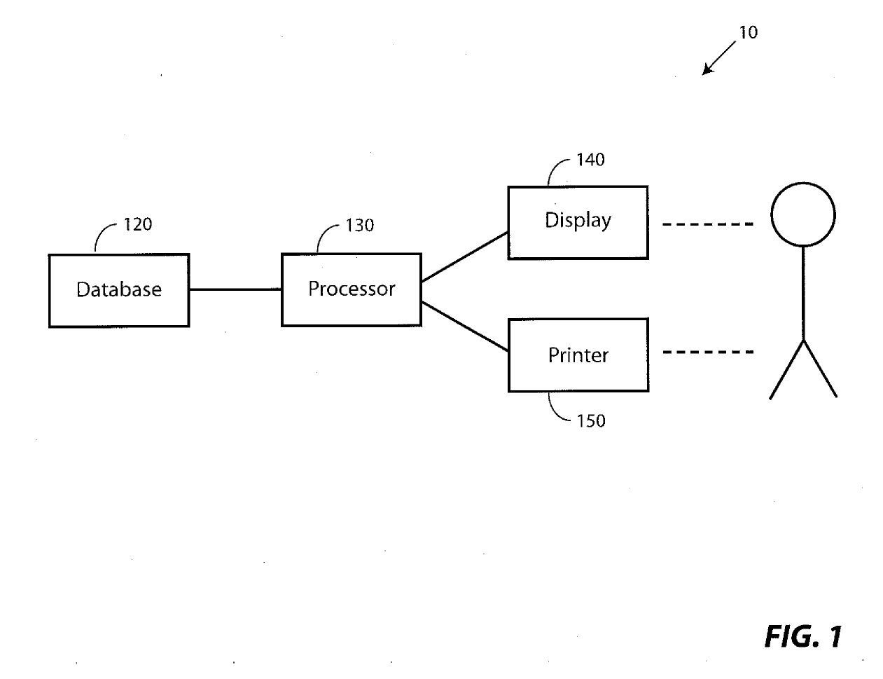

FIG. 1 shows a block diagram of a seating system 10 for an airline. Database 120 stores the seating configuration of the aircraft for a flight, seat assignments for the flight, and may include other relevant information such as passenger identification and frequent flyer status. In general, the database may store seat assignments for many or all of the airline's flights during a certain period of time (e.g., all flights in the next 365 days). For each seat on a given flight, the database contains information that either identifies the assigned passenger or reflects that the seat is currently unassigned.

Database 120 is coupled to a processor 130 that may perform a variety of functions, including updating seat assignments that are stored in the database. The processor may also access one or more of the seat assignments so that they may be displayed to a passenger or other end user on display 140. The display may be the screen of a laptop, desktop computer, or smartphone, or other device operated by the user, or a screen built into an airport check-in kiosk. In the former case, information would be communicated between processor 130 and display 140 over the Internet or some other network (not shown). The processor may be coupled to a printer 150 so that an end user may print a boarding pass or other document reflecting his seat assignment. The printer may be coupled to the user's laptop or other device.

Although system 10 is described in the context of being operated by an airline, it need not be. For example, it may be the system for several airlines, part of one airline, or a third party such as a consolidator, travel agency, or service like Travelocity or Expedia.

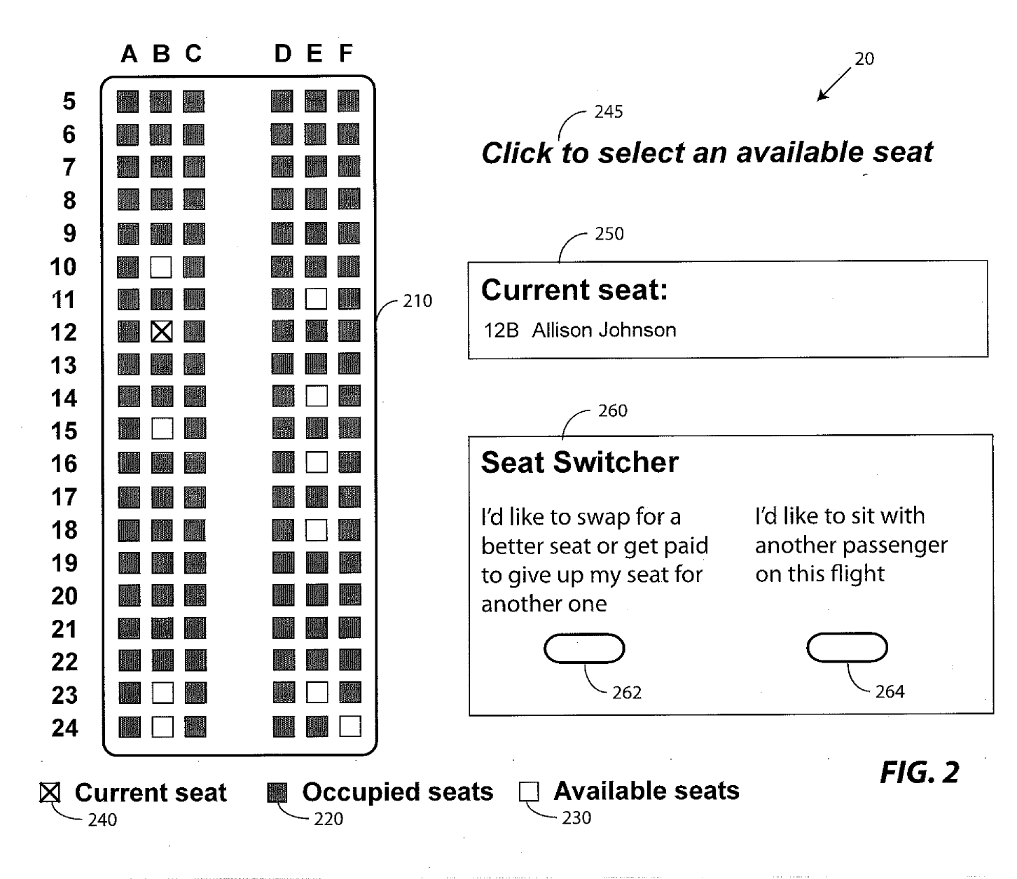

FIG. 2 shows one embodiment of a user interface 20 that may be displayed on display 40 to enable a passenger to select seats on a particular flight. Seat map 210 may use color coding, grayscale shading, X marks, or other indications of which seats 220 have been preassigned to other passengers and which seats 230 are still unoccupied. If the passenger has been preassigned to a seat, his current seat 240 may be shown as well. In general, the seat map will differ from flight to flight depending on the aircraft anticipated to be used for the flight and the seating configuration for the aircraft (e.g., 3-3 as shown, 2-3-2, etc., where the hyphen indicates an aisle on the plane). Furthermore, on larger planes, only a portion of the seat map may be shown at a time, with a scrolling feature to show seats in other parts of the plane. Pursuant to instruction 245, the passenger may select a seat, or switch to another seat, by clicking on an available seat 230, in which case the seat map and database are updated to reflect the passenger's new seat 240 and (if the passenger switched seats) a newly available seat 230.

It may be the case that the passenger is not satisfied with his seat (or any of the available seats 230 that he could switch to), or that the passenger is willing to give up his seat for another seat, perhaps for appropriate compensation. Or, the passenger may be wish to be seated with someone else who is on the same flight but in a separate airline record. In those cases, the passenger may press button 262 or 264 as desired to request a seat reassignment.

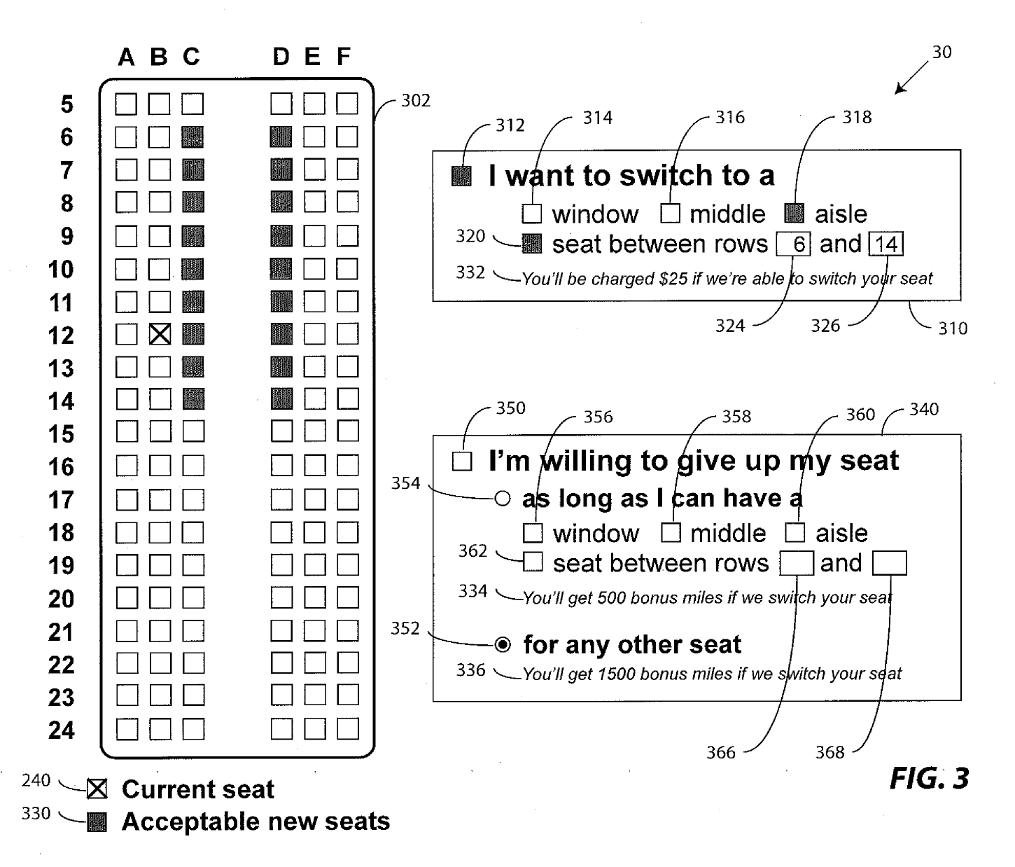

Pressing button 262 displays the user interface 30 of FIG. 3, which includes a seat map 302 that initially displays the passenger's current seat 240. In the example shown, the current seat is 12B, a middle seat on the left side of the plane. Referring to FIG. 3, interface 30 includes a first region 310 wherein the passenger may click checkbox 312 to specify his desire to switch to another seat and select seat attributes (which in the terminology of the present disclosure are a kind of seating preference) for the desired seat. Clicking on one or more of checkboxes 314-320, together with notice 332, specifies conditions for the switch. The first row of checkboxes 314-318 is used to specify the types of seat (here, window/middle/aisle) that are acceptable: Checkbox 320 in the second row is used to specify the locations of seats (here, the rows on the plane) that are acceptable.

For example, if the user wants to try to swap his current seat 240 for an aisle seat between rows 6 and 14, he may click on checkboxes 318 and 320, and then fill in fields 324 and 326 with the numbers “6” and “14.” To provide visual feedback to the user, seat map 302 shows the “acceptable new seats” 330 that correspond to the checkboxes and fields that have been selected. Additionally, the user may check more than one of checkboxes 314-318 if more than one type of seat is acceptable. That is, if the user is willing to take either a window or an aisle, he may click on checkboxes 314 and 318.

Many variations on the above are possible. For example, the passenger may specify other types of seats (e.g., bulkhead seats, exit row seats, seats that recline, seats that have a power outlet, video screen, Internet connection, airphone, etc.) may be specifiable. Conversely, the interface could allow a passenger to specify seats that he is not willing to take (e.g., a bulkhead seat, a non-reclining seat, etc.). Indeed, the interface could permit a specification of acceptable and unacceptable seating preferences (e.g., window seat but not a bulkhead). Other ways to specify desired or undesired location (e.g., left or right side of plane, not the center section on a wide body aircraft, or front third/middle third/back third of plane) may be used as well.

Additionally, checkboxes 314-20 may be preset in their default state to being “unselected” (in which case the passenger would click on the checkbox to select it) or “selected” (in which case clicking would deselect). Indeed, some may be preset to unselected while others are preset to selected, based perhaps on expected passenger inputs or airline preferences.

The interface could also be designed to enable a user to use a mouse, finger, touch screen, stylus, or other selection device to select and/or deselect seats directly on seat map 302. This feature may be used in lieu of, or in addition to, the checkbox interface described above. For example, instead of clicking on any checkboxes, the user could use his mouse to click on seats 7A, 12F, 22A, and 22C if those were the only seats the user wished to try to trade for. Or the user could use the mouse to draw a rectangular “bounding box” whose corners are at seats 6C, 6D, 14C, and 14D as an alternate way to specify the same seats 330 that are shown in FIG. 3 as being acceptable. Then, for example, a superstitious user could click on individual seats 13C and 13D to deselect them and indicate his willingness to sit in any aisle seat in rows 6 to 14 except row 13. Yet another possibility is to maintain a profile with the airline so that when a passenger uses the interface, his profile automatically fills in portions of the seat preferences as appropriate. The passenger may then modify the preselected preferences if desired.

In the example shown in FIG. 3, notice 332 reflects a trade value that has been prespecified by the airline. That is, the seat reassignment request includes a seat attribute chosen by the passenger and a trade value prespecified by the airline. In another embodiment, first region 310 may include a space for the passenger to input a trade value (which may be zero) to indicate what, if anything, the passenger is willing to pay in order to switch to a seat having the requested seat attributes. The trade value can be cash, airline miles, or any other form of payment accepted by the airline and may be presented to the passenger in the form of a pull-down menu. The passenger may also be able to designate from a choice of accounts from which to make the payment including credit card, bank account, frequent flyer account, PayPal account or similar type of account.

The interface of FIG. 3 also includes a second region 340 that may be used to enable a passenger to indicate his willingness to give up his current seat for another seat. In this case, the passenger clicks on checkbox 350. If he is willing to give up his current seat for any other seat of the airline's choice, the passenger selects radio button 352, and the trade is conditioned on the trade value reflected in notice 336. In this ease, the seat attribute reflects the fact that every seat on the plane is acceptable to the passenger. Otherwise, the passenger selects radio button 354 to indicate his willingness to give up his current seat for another seat as long as the switch satisfies the requested seat attributes specified by checkboxes and fields 356-368 and the trade value specified by notice 334. For example, if the passenger is willing to give up his current seat 12B for any other seat as long as it is in the front half of the plane, he would select radio button 354 and checkbox 362, and fill in fields 366 and 368 with the numbers “5” and “14” or similar numbers. As another example, a passenger could specify a willingness to give up a business class seat for a coach seat if he is compensated appropriately (e.g., being paid $200 or 20,000 airline miles for the switch).

Although region 340 is similar to region 310 in terms of choices that are available to the user, it need not be. The choices may be the same, similar or different. Similarly, variations described above for region 310 may be implemented for region 340. Additionally, it may be the case that passengers are willing to switch for no money or miles (e.g., by receiving some form of recognition or merely the satisfaction of helping a fellow passenger). And, as described in connection with first region 310, second region 340 may include a space for the passenger to input a trade value to indicate what the passenger is willing to accept to give up his current seat. This would be an alternative to a trade value prespecified by the airline, as in notices 334 and 336. The trade value can be monetary or non-monetary and can include cash, cash equivalent (e.g., a prepaid card, gift card, etc.), credit, airline miles, rewards points, food/drink vouchers, free seat switch on a future flight, special recognition by the flight crew or on a website, etc. and may be presented to the passenger in the form of a pull-down menu. The passenger may also be able to designate from a choice of accounts into which it wants to receive payment including credit card, bank account, frequent flyer account, PayPal account or similar type of account.

As shown in interface 30 of FIG. 3, a user may click on checkboxes 312 and 350 to indicate multiple reassignment requests in the form of a simultaneous desire to try to trade for a more desirable seat and willingness to give up the current seat for some other seat. This may be an attractive strategy in certain situations, e.g., where the user is trying to get a certain kind of seat but, as a fallback, is willing to give up his seat in exchange for compensation. Alternatively, interface 30 may be implemented with radio buttons instead of checkboxes 312 and 350 to require the user to choose between regions 310 and 340 (trade for another seat, or indicate a willingness to give up a seat, but not both).

In addition, interface 30 could be implemented to allow a passenger to specify multiple seat attributes and trade values as part of multiple reassignment requests. For example, a passenger could specify that he is willing to pay $10 for a window seat, $20 for an aisle seat, or $150 for an upgrade to any seat in the next class of service.

Also, many variations are possible regarding the trade value offered by a passenger trading for a different seat and the trade value received by a passenger willing to give up their seat. As mentioned above, different types of trade values may be designated as a condition for switching seats. The amount of payment could vary depending on the nature of the preassigned and/or requested seats. For example, certain rows or window/aisle seats might require more payment for a passenger requesting to switch to these seats. Or, the payment may increase with the number of conditions the passenger imposes on the seats he is willing to accept. Likewise, more flexibility on the part of passengers willing to give up their seats might result in greater payment to those passengers. The trade value may also depend on the seat to which the passenger is preassigned. For example, if a passenger is preassigned to a middle seat, the trade value for the passenger's willingness to give up his seat for any seat chosen by the airline may be zero (i.e., no compensation), but if the passenger is in a window seat the trade value may be nonzero to compensate the passenger for being willing to give up his seat. Furthermore, the type of payment may vary depending on whether a passenger will be making or receiving payment. For example, passengers requesting a seat swap could be rewarded in one currency (e.g., airline miles or a food/drink voucher) and charged in some other currency (e.g., cash). Also, it may be useful to refer to a trade value as being positive or negative depending on whether the passenger is incurring a cost (e.g., positive trade value) or obtaining a benefit (e.g., negative trade value) for the seat reassignment. These and other variations may result in suitable modifications to the user interface presented to passengers.

In one embodiment, some or all of the trade value paid by a customer may be used to pay the trade value received by a passenger for a successful seat swap. In the case where a passenger has offered to pay more for a seat swap than another passenger has requested to give up a seat, the airline may keep the difference as an additional source of revenue. In the case where a passenger has offered to pay less than another passenger has requested to give up a seat, the airline may pay the difference in order to make more seats available for swap and increase customer satisfaction. In another embodiment, the airline may outsource the seat swap process to a third party provider who may be compensated by the airline, or be compensated by the trade values associated with the seat reassignment. For example, the airline could provide access to its database containing seat attributes and passenger information to the third party provider, and the third party provider could provide such information to the passengers via a user interface hosted on the third party's computer server. The third party provider could require that the passenger provide its record locator or other confirmation number with the seat reassignment request to ensure the seat assignment request is authentic. The third party provider can provide the airline with the seat reassignments indexed by the airline confirmation number provided by the passenger so that the airline can track the seat reassignments and take the appropriate actions. In yet another embodiment, trade values may be paid (i.e., may flow) directly between passengers instead of between each passenger and the airline. In this case, the airline or a third party might take part of the trade value as a fee or commission.

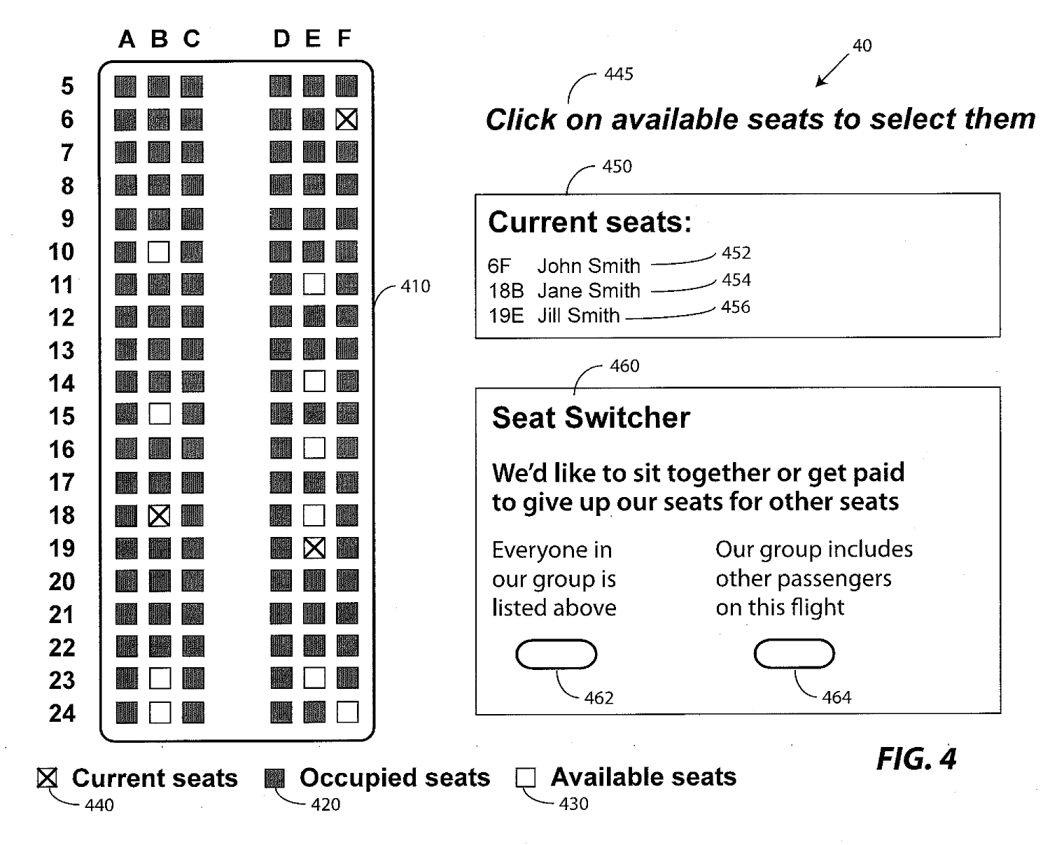

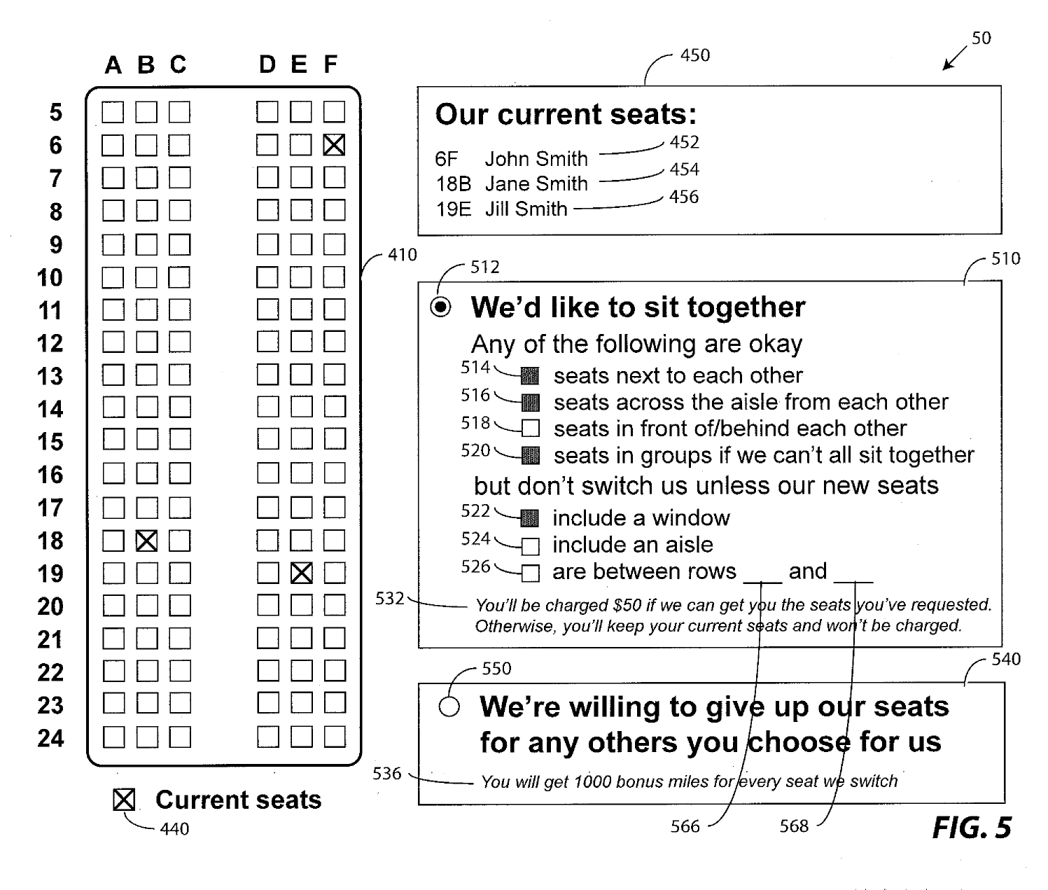

If a passenger is travelling alone, system 10 presents the user interfaces of FIGS. 2-3 on display 140. On the other hand, if multiple passengers are travelling together, system 10 presents the interfaces of FIGS. 4 and 5 on display 140. In the case of multiple passengers, the user, who is typically one of the passengers in the record, clicks on available seats to select a seat for the passengers 452-456 in the record.

If the passengers are not satisfied with their seats, or if they are willing to give up their seats for other seats of the airline's choice (perhaps for appropriate compensation), or if they are travelling with others who are on the same flight but in a different airline record, the user may press button 462 or 464 as desired to submit a group reassignment request. (A group reassignment request reflects a reassignment request by two or more passengers.) Pressing button 462 displays the user interface 50 of FIG. 5, which includes a seat map that displays the current seats 440 assigned to passengers 452-456. In the example shown, the current seats are 6F, 18B, and 19E.

Referring to FIG. 5, interface 50 includes a first region 510 wherein the user may click on radio button 512 to specify the passengers' desire to sit together. Clicking on one or more of checkboxes 514-520 enables the user to specify what he considers to be seats that are “together.” For example, if the three passengers want three consecutive seats in the same row without an aisle separating them, the user would click on checkbox 514 but not checkboxes 516-520. As another example (shown in FIG. 5), if checkboxes 514, 516, and 520, but not 518, are checked off, the system will attempt to swap the passengers' current seats for seats that are next to each other and/or across the aisle from each other. Because checkbox 520 is checked off, if the system cannot find three seats that together satisfy the constraints of checkboxes 514 and 516, the system will attempt to find smaller groups of seats (e.g., two seats and one seat) where each smaller group satisfies the constraints. Thus, the more of checkboxes 514-520 that are checked off, the broader the user's definition of “together” is and the more likely a seat reassignment request will be fulfilled. Indeed, it may be desirable to implement a system wherein certain checkboxes are pre-selected, and enable the user to deselect one or more of them to restrict the scope of seating configurations that are considered to be together. Or, it may be desirable to charge passengers less if they select more of checkboxes 514-520.

In some cases, the number of passengers in the record may determine checkboxes or combinations of checkboxes that are disabled (e.g., “grayed out”). For example, if there are only two passengers in the record, checkbox 520 may not be shown, or may be disabled such that it cannot be selected, because only two passengers cannot be seated in smaller groups. As another example, if there are more than three passengers in the record and if box 514 is checked, the system may force the user to additionally check at least one of boxes 516-518.

The user can also specify additional seating preferences that the new seats must satisfy (in addition to being together) using checkboxes 522-526 and fields 566-568. This provides passengers with more control over a seat swap. For example, if the passengers 452, 454, 456 in the record include a child, they may want to switch into seats that are together, but only if the new seats include a window seat. In this case, the user would check off box 522, and if seats that are together but do not include a window are found (e.g., seats 6B, 6C, 6D), the passengers' seats will not be changed. Additionally, the user may check off more than one of checkboxes 522-526 if desired (e.g., if he wants the group(s) of seats to include both a window seat and an aisle seat, he would check off boxes 522 and 524). Thus, the fewer of checkboxes 522-526 that are checked off, the more likely that a successful seat swap can be made.

The interface of FIG. 5 also includes a region 540 and radio button 542 that may be used to enable passengers to indicate their willingness to give up their current seats for other seats of the airline's choice. A resulting seat swap is conditioned on the compensation offer set forth in notice 536.

Although not shown in FIG. 5, interface 50 could be designed to allow passengers to give up their current seats for another seat as long as the seat switches satisfy certain conditions, e.g., the seating preferences specified by some or all of the checkboxes and fields in region 510. This would enable, for example, passengers to indicate their willingness to give up their seats for other seats as long as the new seats included, say, an aisle seat. Likewise, although FIG. 5 uses radio buttons 512 and 542 to force the user to choose between regions 510 and 540, interface 50 alternatively could be designed using check boxes instead of radio buttons (along the lines of interface 30 in FIG. 3). In that case, a user would be able to click on both checkboxes to indicate a simultaneous desire to try to trade for more desirable seats and a willingness to give up the current seats for other seats.

As discussed above in connection with the single passenger interface, many variations on the above-described multi-passenger interface are possible. These variations include, for example, those relating to types of seat, location of seat, acceptable and unacceptable seat attributes and other seating preferences, trade values specified by the airline or user, selection devices, checkbox defaults, multiple reassignment requests by a user, and so on.

Furthermore, although the above describes one of the passengers in the record (referred to as “the user”) selecting seats and specifying conditions for a seat swap, one or more of the other passengers in the record may do the same, e.g., subsequently access the record to enter his own seating preferences and/or trade values for a seat swap. The subsequently entered seating preferences or trade values may be used in a variety of ways depending on system implementation. For example, they may replace those that were originally entered by the user. Or, they may augment those that were entered by the user. Or, the intersection or overlap may be used (e.g., if the user specified “window or aisle in rows 6 to 14” and another passenger in the group subsequently specifies “window in rows 5 to 10,” the overlap is “window in rows 6 to 10”). Or, the user may specify that his seating preferences and/or trade values may not be modified or otherwise overridden by another member of his group.

In addition, although not shown in FIGS. 4 and 5, individual passengers in a group (e.g., in an airline record) may request seat reassignments on an individual basis using interface 30 of FIG. 3 or a similar interface. For example, if daughter Jill Smith 456 in the Smith family 452-456 prefers to sit without her parents in a seat that satisfies certain requirements, she may specify her preference to be treated as an individual (e.g., using an additional button, not shown, in FIG. 4) and then submit a seat reassignment request for herself using interface 30. Her parents could then submit their own reassignment request (e.g., specifying their desire to be seated together or their willingness to give up their seats for compensation). In a similar manner, multiple passengers in a group may split off from the group to submit a reassignment request for their subgroup using interface 50 of FIG. 5. For example, if the Smith family included two children, the children could submit one reassignment request using interface 50. The parents could also submit their own reassignment request if they wanted to.

Referring again to FIGS. 2 and 3, it may be the case that the passenger using interface 20 may be travelling with other passenger(s) who are on the same flight but in a separate airline record. For example, business colleagues who are travelling together typically are in different airline records. Likewise, the passengers using interface 40 in FIGS. 4 and 5 may be travelling with others on the same flight but in a separate record. This can occur, for example, when a businessman brings his family along on one of his trips. If his ticket is purchased by his company, while his family's tickets are purchased separately using personal funds, his ticket and his family's tickets typically will be in two different records. Likewise, separate records can arise when multiple families, friends, schoolchildren, or other groups are travelling together.

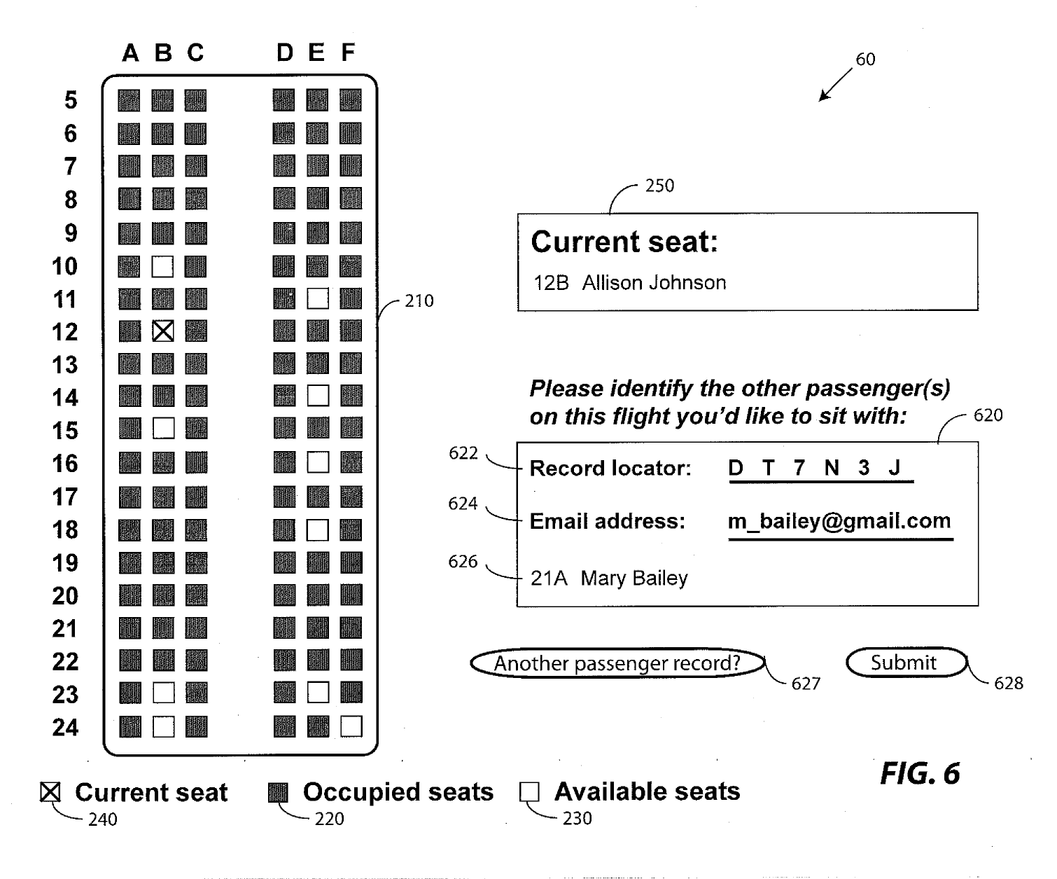

The present disclosure describes systems and methods that allow passengers in multiple records to link their records so that the records can be used and processed together for purposes of seating, seat preassignments, seat reassignments, or other purposes. For example, in the case of a record with a solo passenger, the user may click on button 264 in FIG. 2, which results in the display of the user interface 60 of FIG. 6, and the passenger's name and current seat assignment in region 610. The user then fills in fields 622 and 624 in region 620 to specify the record locator of potential seatmate(s) with whom she would like to sit, along with their email address for purposes of notifying the potential seatmate(s) of the user's request to sit with them and obtaining the potential seatmate's permission to be seated with the user. (In the terminology of this disclosure, the passenger's desire to sit with the potential seatmate is a seating preference for the passenger.) If the information in field 622 matches the record locator of other passenger(s) on the flight, their names 626 are displayed. Alternatively, the interface may refrain from displaying the names of another passenger until the other passenger gives permission to be seated with the user. In the example shown in FIG. 6, the record locator entered in field 622 corresponds to one passenger and potential seatmate, Mary Bailey.

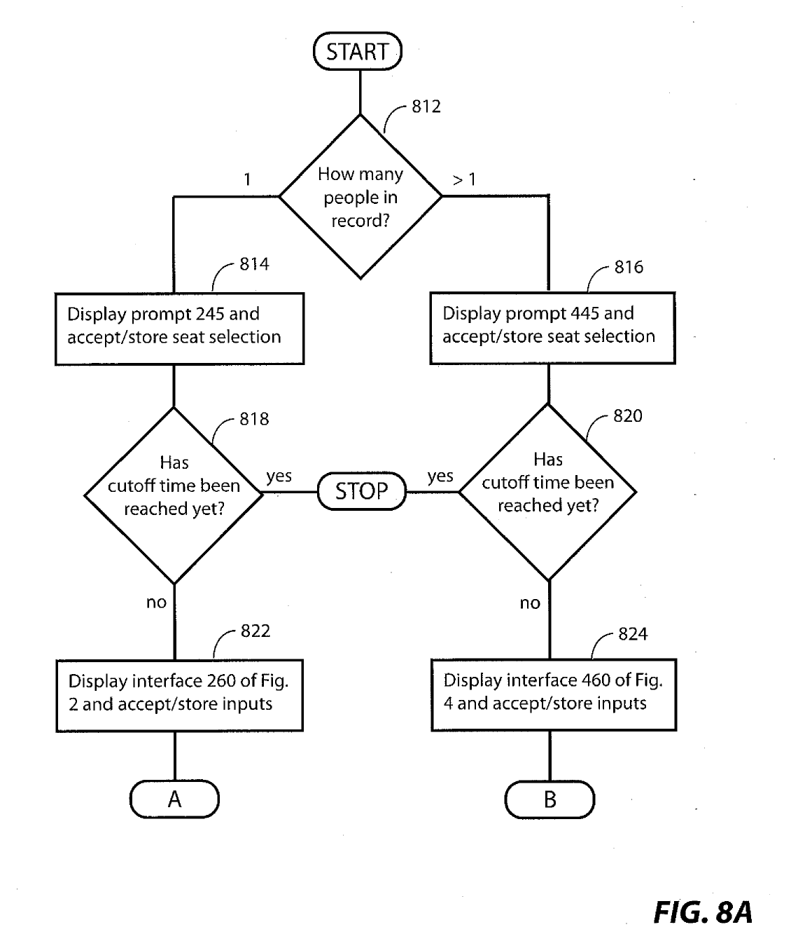

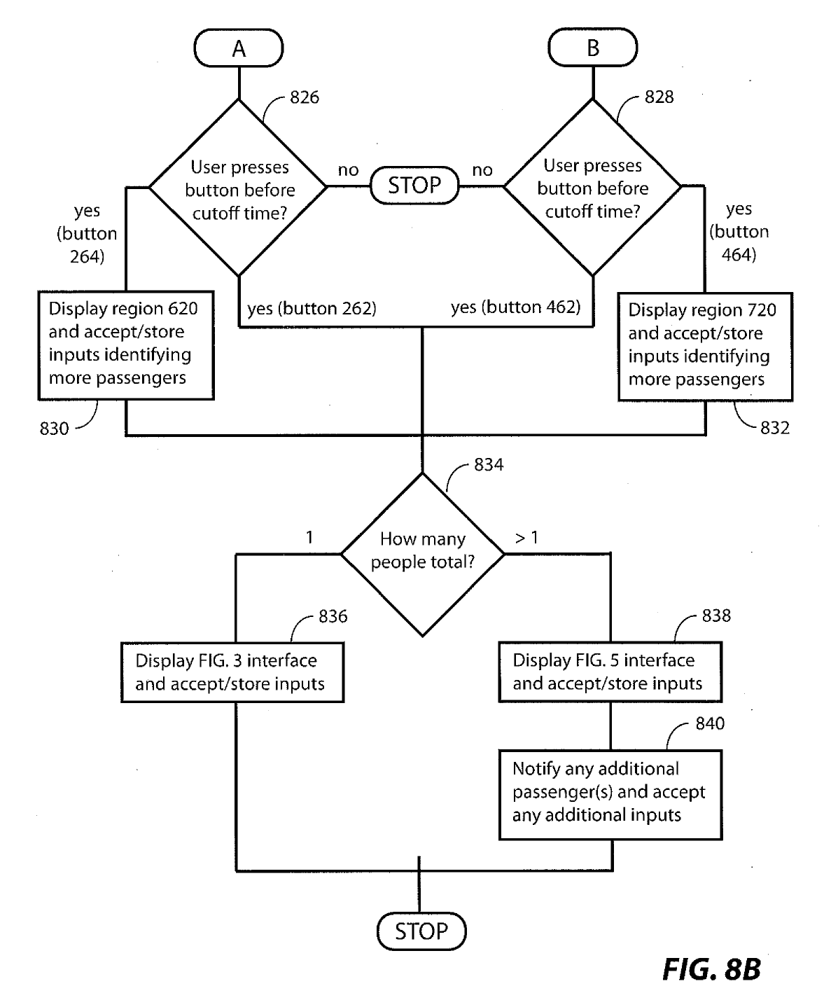

Once the user is satisfied that the correct potential seatmate has been identified, the user may click on button 627 to identify and add one or more passengers in yet another record, or click on button 628 to proceed to interface 50 of FIG. 5. (Instead of displaying the names of passengers 452, 454, and 456—John Smith, Jane Smith, and Jill Smith—in this case region 505 would list the user Allison Johnson and her potential seatmate Mary Bailey). The user would then specify preferences and conditions for being seated together with the potential seatmate using radio button 512, checkboxes 514-526, and fields 528-530, or to indicate the willingness of passengers Johnson and Bailey to give up their seats for other seats chosen by the airline using radio button 542 (pending confirmation by Bailey as discussed below in connection with step 840 of FIG. 8). Thus, once a user has specified his preference to sit together with one or more potential seatmates, he may use the same interface 50 that is used for multiple passengers in the same record.

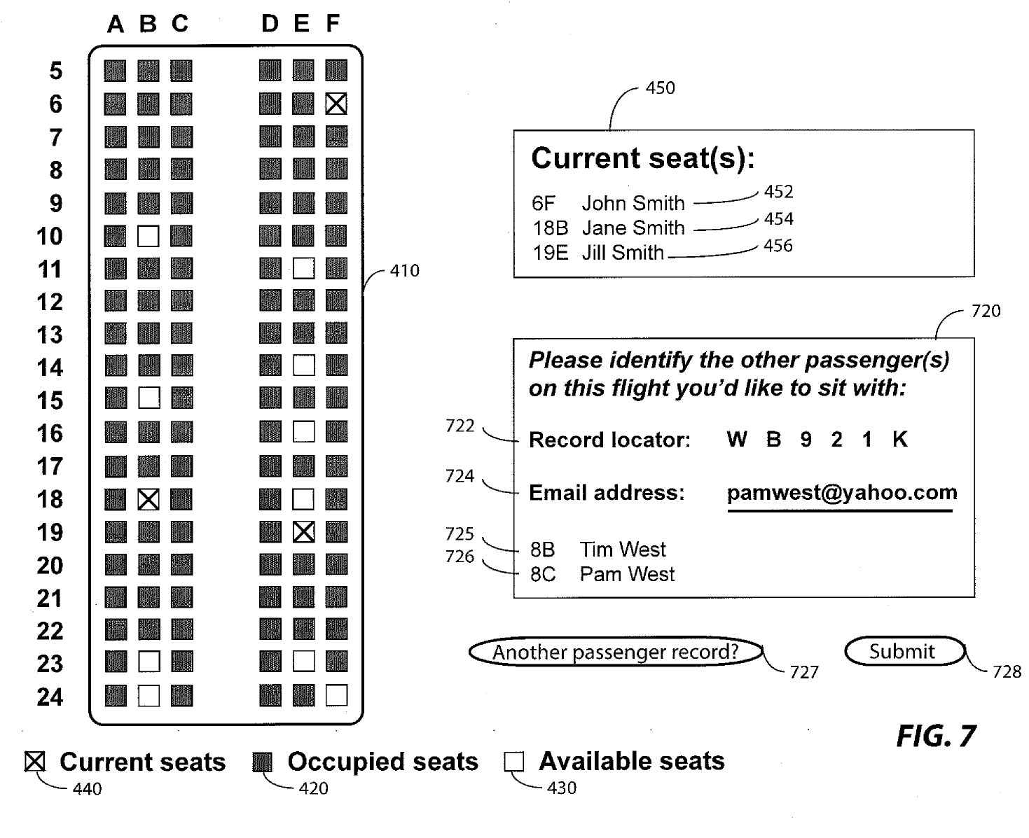

In the case where multiple passengers in one record wish to sit with one or more passenger(s) (i.e., potential seatmate(s)) in a different record, one of the multiple passengers (the user) may click on button 464 in FIG. 4, which results in the display of the user interface 70 of FIG. 7. The user then fills in fields 722 and 724 in region 720 as discussed above in connection with FIG. 6, views a list of potential seatmate(s), here Tim West 725 and Pam West 726, and then may click on button 727 to identify and add one or more passengers in yet another record, or click on button 728 to proceed to interface 50 of FIG. 5. (In this case, region 505 would display the names of the Smith and West family members.) The user would then specify preferences and conditions for the Smith and West family members being seated together using radio button 512, checkboxes 514-526, and fields 528-530, or to indicate the willingness of the Smith and West family members to give up their seats for other seats chosen by the airline using radio button 542 (pending confirmation by the West family as discussed below in connection with step 840 of FIG. 8).

Many variations are possible for the information supplied in fields 622 and 624 of FIG. 6 or fields 722 and 724 of FIG. 7. For example, the passenger(s) could be identified by specifying their names, employer, seat numbers, telephone number, social security numbers, credit card numbers, etc. Similarly, the notification could be done in other ways (e.g., via text, using a phone or fax number, by mail, etc.) with appropriate information provided in field 624 or 724 in lieu of an email address.

Other variations may permit the automatic identification of a group of passengers who are travelling together. For example, when business colleagues from the same company are travelling on a flight, their common affiliation could be used to identify that they may want to be considered as a group, and to enable the specification of seating preferences that reflect their desire to have their airline records linked together or otherwise reflect their desire to sit together (or, indeed, to sit apart). If available to the airline, other information about passengers (e.g., age group, AARP membership, hometown, educational institution, and so on) could be used in a similar way to establish seating preferences.

FIG. 8 is a flowchart of a process that may be run on processor 130. In step 812, a test is made to determine how many passengers are in the record.

If there is only one passenger, user interface 20 of FIG. 2 is displayed on display 140 in step 814, enabling a user to select an unoccupied seat in response to prompt 245. In one embodiment, the airline may establish a cut-off time, e.g., 24 hours before flight time, before which all seat reassignment requests must be made. If the cutoff time has been reached, as tested in step 818, the passenger is not offered an opportunity to request a seat reassignment. If the cutoff time has not been reached, region 260 of FIG. 2 may be displayed in step 822 to offer the passenger several options to switch seats. One option, associated with button 262, enables the passenger to try to switch to a better seat or get paid to give up his or his seat for another seat on the flight. Another option, associated with button 264, gives the passenger a way to designate other(s) on the flight as potential seatmate(s).

If the passenger accepts the offer by pressing button 262 before the cutoff time, as tested in step 826, test 834 will return a “1” and a suitable interface such as interface 30 of FIG. 3 may be displayed enabling the passenger to specify his desire to trade for a new seat and/or willingness to give up his seat for another by specifying seating preferences and a trade value if applicable.

If, on the other hand, the passenger accepts the offer by pressing button 264 before the cutoff time, as tested in step 826, the passenger will use the interface of FIG. 6, and in particular region 620, to specify potential seatmate(s). Then, test 834 will reflect that there are multiple passengers travelling together, and the passenger will be presented in step 838 with the interface of FIG. 5 to specify his preferences for being seated together with the potential seatmate(s) (as described above in connection with FIG. 5) in the form of a group reassignment request. In step 840, the potential seatmate(s) are informed, e.g., by email, about the fact that the passenger wishes to sit with the potential seatmate(s), along with the seating preferences entered by the passenger in the interface of FIG. 5. The potential seatmate(s) are invited to accept or reject the group reassignment request submitted by the user, including accepting or rejecting the invitation to sit together as well as accepting the seating preferences entered by the passenger or entering their own preferences. Finally, if the passenger does not press either of buttons 262 or 264 before the cutoff time, no further seat switching interfaces are presented.

If the test of step 812 reflects that there are multiple passengers in the record, user interface 40 of FIG. 4 is displayed on display 140 in step 816, enabling a user to select unoccupied seats in response to prompt 445. A test is then made in step 820 to determine whether there is still enough time left to allow seat switching (e.g., it is still more than 24 hours before the scheduled flight time). If there is enough time, in step 824, region 460 of FIG. 4 is displayed to offer the passengers several options to switch seats. One option, associated with button 462, enables the passengers to try to sit together or get paid to give up their seats for other seats on the flight. Another option, associated with button 464, gives the passengers a way to designate other(s) on the flight as potential seatmate(s).

If the user accepts the offer by pressing button 464 before the cutoff time, as tested in step 828, the user will use the interface of FIG. 7, and in particular region 720, to specify potential seatmate(s). Then, test 834 will reflect that there are multiple passengers travelling together, and the user will be presented in step 838 with the group reassignment request interface of FIG. 5 to specify the passengers' preferences for being seated with the potential seatmate (as described above in connection with FIG. 5). In step 840, the potential seatmate(s) are informed, e.g., by email, about the fact that the passengers wish to sit with the potential seatmate(s), along with the seating preferences entered by the user in the interface of FIG. 5. The potential seatmate(s) are invited to accept or reject the invitation to sit with the passengers, as well as to accept the seating preferences entered by the user or enter their own preferences.

If the user accepts the offer by pressing button 462 before the cutoff time, as tested in step 828, test 834 will indicate multiple passengers and the user will be presented with the interface of FIG. 5 to specify his preferences for a group reassignment request. (In this case, because there are no potential seatmate(s) to be notified, step 840 is not performed.) Finally, if the user does not press button 462 or 464 before the cutoff time, no further seat switching interfaces are presented.

In one embodiment, once a cutoff time has been reached the system implements an algorithm to identify a new set of seat assignments that achieves a sufficiently good or optimal value of a desired parameter (e.g., number of satisfied passengers, revenue generated by seat switches, etc.). The system may notify affected passengers of their new seat assignments (e.g., via telephone, mail, email, text, or social networking) and charge or compensate passengers as appropriate. When passengers obtains their boarding passes (e.g., by printing them online or obtaining them at an airport kiosk or from a ticket agent), the boarding passes will reflect the new seat assignments, and may indicate that a switch has been made together with indication of any payment or compensation.

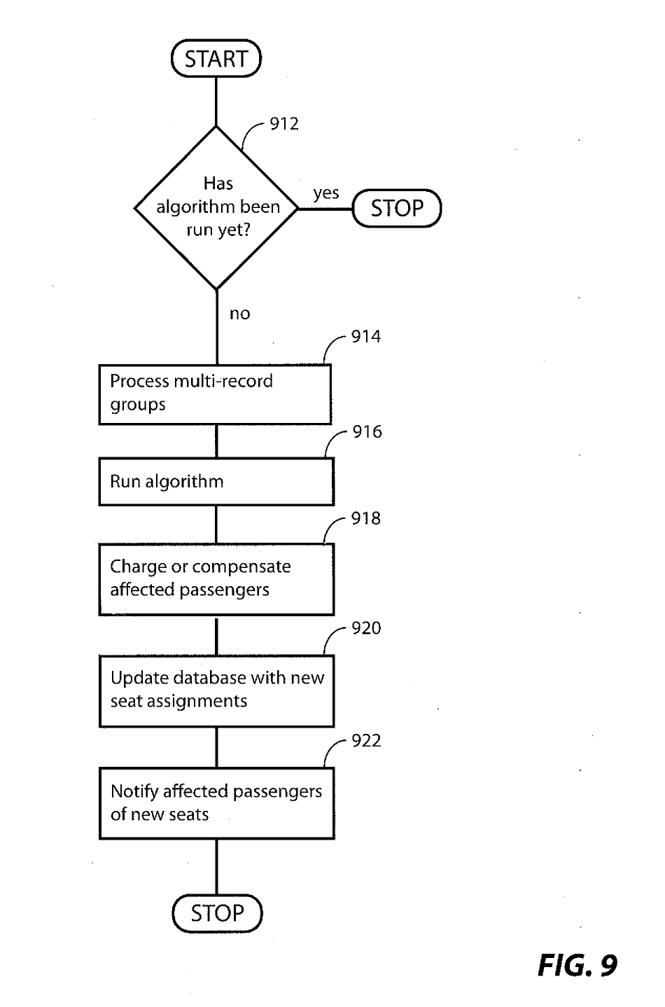

FIG. 9 illustrates one embodiment of a method to reassign seats. Once the cutoff time has been reached (and if any passengers have inputted information using interface 30 and/or 50), processor 130 determines whether it has already run an algorithm in step 520. The algorithm, an example of which is described in greater detail below, takes passenger data inputted in step 836, 838, and/or 840 and processes that data to yield a set of new seat assignments that is deemed to be sufficiently good according to some selectable metric, e.g., in terms of the number of seat switches that are accomplished, revenue to the airline, etc.

If the algorithm has not yet been run, any multi-record groups are processed. A multi-record group can result from requests for potential seatmate(s), as described in connection with FIGS. 6 and 7. In processing a multi-group record, the system determines whether potential seatmate(s) have accepted the invitation of the requesting passenger to sit together. If the invitation has been accepted, the system processes the seating preferences entered by the requesting passenger and (if they have been entered) by the potential seatmate(s). Any discrepancies may be reconciled in any of several ways, e.g., by taking the intersection of the preferences, allowing the potential seatmate(s)' preferences to dominate, etc.

An algorithm is then run in step 916, and in step 918, passengers whose seats have been switched are either charged or provided compensation in accordance with the conditions set forth in the seat reassignment request (e.g., pursuant to notices 332, 334, and 336 of FIG. 3 and notices 532 and 536 of FIG. 5). The processor may accomplish this step by charging the credit or debit card that is on file (e.g., that the passenger used to purchase his ticket), deducting miles from or crediting miles to a mileage account, issuing a coupon for free food/drinks using printer 150, etc. Then, in step 920, database 120 is updated to reflect seat reassignments and affected passengers are notified of their new seat assignments in step 922.

Many variations on the above are possible. For example, it may be desirable to confirm, in advance of running the algorithm in step 916, that each passenger requesting a seat reassignment will be able to pay for the swap. This could be accomplished by running a preauthorization of the credit card at the time the passenger uses interface 30 or 50, and requesting a different form of payment if the preauthorization is declined. Or, in the case of airline miles, the passenger's mileage account could be checked, and the appropriate number of miles could be provisionally deducted or frozen, pending a successful seat swap involving that passenger in step 916.

Similarly, in some cases it may be desirable to charge the passenger for the seat reassignment at some point in time before the reassignment is accomplished in step 916. For example, the passenger could be charged an additional amount (say, $15) as part of the cost of the air ticket if he is not satisfied with available seats, or his preassigned seat, and wishes to submit a seat reassignment request at the time of purchase. In this case, the additional amount of money (or a lesser amount of money, airline miles, or something else of value) that is charged upfront could be refunded to the passenger if the reassignment request is not fulfilled. In an alternate embodiment, the upfront charge is nonrefundable, i.e., may not be refunded even if the reassignment request is unfulfilled. Further, the passenger could be charged less if he makes an upfront payment rather than paying after reassignment occurs. If charged upfront, the passenger could choose to submit a reassignment request at the time of booking, sometime later, or not at all. Where an upfront payment is made, an additional amount may be due upon a successful reassignment. Charging the passenger for the reassignment upfront as described in the foregoing may facilitate expense reports in a business travel context, for example, or dispense with the need to preauthorize as described above.

Also, it may be desirable to run the algorithm more than once. For example, certain passengers may be willing to pay more to have their seats swapped when a match becomes available (or at least without having to wait until, say, 24 hours before the flight time). In this case, the algorithm could be run in advance for those passengers, and again later on, and more times in between, as appropriate. For example, the algorithm could be run periodically, e.g., hourly, daily, etc., or could be run on a rolling basis every time a new seat request or certain number of seat requests are received. If the algorithm is run multiple times, it may be that certain passengers are notified of their reassignments, while others are not reassigned or not notified until a later time.

In one embodiment, the cutoff time may be selected such that it is earlier than the first time when passengers may check in and print their boarding passes. However, swapping even after passengers are allowed to check in and print their boarding passes is possible. In this case, if passengers are swapped, they could be notified, for example, by a text message, email, or at the gate at the time of boarding. The payments to/from passengers could be different for swaps made after a cutoff time. For example, a passenger could be charged more if a change request is made and accommodated after passengers are allowed to check in and print boarding passes.

It is also possible for seat reassignment requests to be made without visual interfaces such as those depicted in FIGS. 2-7. For example, a passenger who is speaking with an airline reservations agent may select a seat from those that are available, and then specify conditions for a seat switch. The information could be entered by the reservations agent into one or more interfaces and then stored in database 120 for later access by processor 130. Thus, some passengers could use the interfaces of FIGS. 2-7 to submit seat reassignment requests, while others could do so by telephone with a reservations agent, or in still other ways, e.g., using a touch-tone interface, automated voice recognition system, or the like.

Many different algorithms may be used to process the seat requests and find a suitable solution. Before discussing these algorithms, it is useful to introduce certain terminology as background. An airline passenger typically, though not always, selects or is assigned a seat in advance of his flight, in which case we will say that the passenger is preassigned a seat or that the given seat is preassigned to the passenger. Although the passenger may wish otherwise, it is understood by convention that a seat change may not be possible and that the passenger may have no choice but to remain in his preassigned seat. We will say that the preassigned seat is a valid seat for the passenger even though he may desire or be willing to switch to a different seat.

In addition to his preassigned seat, the passenger may indicate seating preferences and trade values for a seat switch. Any seat to which the passenger indicates a desire or willingness to switch (based on the indicated seating preferences and trade values) will also be called a valid seat for that passenger. If a passenger is preassigned a seat and does not indicate an interest and/or willingness to switch to other seats, then the preassigned seat is defined to be the only valid seat for this passenger.

If a passenger who has not been preassigned a seat has preferences that can be accommodated with seats that are available to him (i.e., unoccupied) at that time, then he can simply select a seat satisfying his preferences. If not, then he can still select any of the available seats. In either case, if the passenger selects a seat he will then be considered a preassigned passenger preassigned to the seat he selects. If a passenger does not select one of the available seats and thus remains without a preassigned seat, then every seat will be considered to be a valid seat for the passenger. Such a passenger may or may not provide seating preferences with seat attributes and trade values, and if provided, these may, though need not, be taken into consideration in the reassignment.

Depending on characteristics of the passenger and constraints imposed by the airline, the FAA, or some other agency, certain seats may automatically be defined as invalid seats for that passenger. For example, if the passenger is a child then a seat next to an emergency exit may be defined to be invalid.

A configuration refers to an assignment of each of the preassigned passengers to a unique seat. A configuration is called valid if every preassigned passenger is assigned to a seat that is valid for that passenger, according to that passenger's criteria as described above. Otherwise, the configuration is called invalid. That is, a configuration is invalid if at least one preassigned passenger is assigned to a seat that is invalid for that passenger.

Since the preassigned seat is always a valid seat for a passenger, the preassigned configuration is always a valid configuration. However, while the preassigned configuration is valid in the sense defined above, there may be other configurations that are more desirable in terms of accommodating preferences of one or more of the passengers. To achieve these more desirable configurations, it may be necessary to move one or more of the preassigned passengers to different seats.

In the prior art, individual passengers are able to switch their seats independently of one another based on their own individual seating preferences, but moving passengers based on joint consideration of their seating preferences or jointly moving two or more passengers has not been practiced. The joint consideration of passengers enables efficient movement to desirable configurations that would be inefficient, unlikely, or impossible with individual moves. The three cases below illustrate examples of the benefits of jointly considering reassignment requests.

Case 1. In some situations, a sequence of individual moves can lead to new configurations that fulfill preferences of multiple passengers. For example, suppose passenger 1 is preassigned to an aisle seat but would prefer a window seat, while passenger 2 is preassigned to a window seat but would prefer an aisle. If there are window and/or aisle seats available or if one of these types of seats becomes available through some other passenger switching their seat or canceling their ticket, then it may be possible that both passengers 1 and 2 are able to fulfill their desire by independently switching their seats. Specifically, one of the passengers, say passenger 1, might notice that a window seat has become available and change his seat. At a later time, passenger 2 then notices that the aisle seat that was vacated by passenger 1 is available and she can move to this aisle seat. Such a move may or may not occur depending on whether the passengers check availability at the right times. However, the present invention enables an efficient method for accomplishing such a switch by jointly using the preference information of multiple passengers. Without joint consideration of reassignment requests, the moves of individual passengers are uncoordinated, making the desired sequence of moves less likely to occur since it requires a sequence of moves to occur independently when there may be a very large number of possible moves. On the other hand, by jointly considering the reassignment requests, the moves of multiple passengers can be coordinated to achieve the desired passenger moves.

Case 2. In other cases, while it is possible to make a sequence of individual switches to a more desirable configuration, the required individual switches generally do not occur in practice. For example, as before, suppose that passenger 1 is preassigned to an aisle but would like a window, while passenger 2 is preassigned to a window but would like an aisle. Suppose that a middle seat is available, but that neither passenger wants a middle seat. That is, they both prefer their current seat over a middle seat. Then, in principle, the following sequence of individual switches could occur. One of the passengers, say passenger 1, could switch from his aisle seat the available middle seat. This would open an aisle seat, into which passenger 2 could switch. Then passenger 1 could switch into the open window seat vacated by passenger 2.

While this sequence of individual switches may be theoretically possible, in practice passenger 1 will not make the first individual switch since he is moving to a less desirable seat and does not know that further switches might occur which might lead to a more desirable seat. In the terminology above, the first switch moves passenger 1 into a seat he considers invalid, so that the sequence of individual switches passes through an invalid configuration on the way to the final desired configuration.

On the other hand, with the present invention, by jointly considering the reassignment requests of both passengers, the desirable configuration can be computed and performed. With a joint switch of passengers 1 and 2, the original configuration can be transformed in one step to the final desired configuration. Or, if transitions through invalid configurations are allowed, then a joint switch can be mimicked by a sequence of individual switches by first placing one passenger in the empty middle seat as described above. This sequence of switches may be one of many algorithmic approaches for computing desirable configurations even though passengers are not actually reassigned or notified of the intermediate steps.

Various other attempts can be made to try to mimic the moves that can be made through joint consideration of reassignment requests using a sequence of individual moves that try to circumvent the notion of transitions through an invalid configuration described above. For example, one can take a particular empty seat in a flight and define it as valid for every passenger. In this way, one can transition from any valid configuration to any other valid configuration by using this special seat that has been defined to be universally valid as swing space that makes it possible to move passengers around while always maintaining a valid configuration. Another possibility is to create a phantom seat that does not actually exist and define this as a seat that is valid for all passengers. One can then again move from any valid configuration to any other valid configuration without passing through an invalid configuration. However, a problem with these and other similar attempts is that if the notion of valid seats does not conform with desires of the passengers, then passengers will be unlikely to make the seat changes needed to move from one valid configuration to another. On the other hand, by jointly considering the reassignment requests of multiple passengers, the airline or other third party that is carrying out the reassignment can facilitate moves that would otherwise be unlikely to take place.

Case 3. There are also cases in which it may not be possible to accommodate passengers 1 and 2 by a sequence of individual switches. For example, suppose the flight is full and all passengers are preassigned seats. Then there are no empty seats for any passengers to switch to. Yet, by jointly considering the preferences of passengers 1 and 2, a more desirable configuration can be computed and by jointly switching passengers 1 and 2 it is possible to fulfill the desires of both of these passengers. Namely by putting passenger 1 in the seat preassigned to passenger 2 and putting passenger 2 in the seat preassigned to passenger 1, both passengers are accommodated. In this case, one can try to mimic jointly moving passengers 1 and 2 by creating an extra empty phantom seat and making individual moves using this phantom seat. However, again such moves will not occur in practice with passengers making individual moves in an uncoordinated fashion since individual passengers are unlikely to choose to move into the phantom seat. This and other methods that do not coordinate the reassignment requests cannot efficiently make the moves that can be facilitated by jointly considering the reassignment requests.

In situations like Case 1 above, a sequence of individual passenger moves exists to transform the preassigned configuration to a new valid configuration where each move is a valid move. In this sense, we will say that the two configurations are connected, or that the two configurations are part of the same connected component of valid configurations. However, while every move is valid and so can be realized by individual valid moves, the transition can be made much more efficiently by jointly considering the reassignment requests. In situations like Case 2, every sequence of individual passenger moves that transitions from the preassigned configuration to the new valid configuration passes through an invalid configuration. In this sense, the preassigned configuration and the reassigned configuration are not connected. That is, the two configurations are not part of the same connected component of valid configurations. In this case, while it is possible to sequentially move individual passengers to achieve the reassigned configuration, such a sequence is not likely to occur because it requires one or more passengers to make a move that the passenger does not desire. In situations like Case 3, no individual moves are possible since there are no empty seats.

Given this background, we turn to a discussion of algorithms that may be run by processor 130 to accomplish seat reassignments. In step 916 of FIG. 9, one such algorithm is run to determine which seat changes, if any, will be made. The algorithm used to identify a new set of seat assignments may attempt to find a sufficiently good or optimal value of a desired parameter (e.g., number of satisfied passengers, revenue generated by seat switches, etc.). While a variety of methods could be used to determine a satisfactory set of new seat assignments, described below is one suitable embodiment.

Let N denote the number of seats on the aircraft under consideration on the aircraft. Let K denote the number of passengers under consideration. For example, if first class seats and passengers are not part of the switching possibilities, they can be excluded from the N seats and K passengers, respectively. For each passenger i=1, 2, . . . , K, database 120 contains information on the details of the passenger. And for each seat j=1, 2, . . . , N, the database contains information on the location and type of seat (e.g., which row and position the seat is in, whether it is a window, middle, or aisle, etc.). This information depends on information about the type of aircraft used for the particular flight which is also contained in database 120.

For simplicity in the explanation below, we can assume that the number of passengers is equal to the number of seats, that is K=N. If this is not the case, one approach is to introduce N−K “ghost passengers” so that if K includes the real passengers together with the ghost passengers then we have K=N. There may be other ways to deal with the case in which the number of real passengers is less than the number of seats under consideration.

Each passenger needs to be assigned to a unique seat. We'll represent a seating assignment by a permutation of the integers 1, . . . , N. A permutation p can be thought of as an ordering of the integers 1, . . . , N or equivalently as a one-to-one and onto mapping p: {1, . . . , N} [symbol] {1, . . . , N}. Each permutation represents a unique association between passengers and seats with passenger i assigned to seat p(i).

Some passengers may have indicated preferences or willingness to change seats in groups. Others may have indicated preferences alone, while still others may not have indicated any preferences. Let G₁, . . . , G_{M} denote the different groups of passengers, and let s₁, . . . , s_{M} denote the corresponding size of each group. Let G₀ denote the set of passengers who indicated individual preferences as well as those that indicated no preferences. G₀ also includes any ghost passengers if these are used. Let s denote the number of passengers in G₀.

By construction, the Gₘ are disjoint and every passenger belongs to one of the Gₘ. Namely,

$${G}_{l} ⋂ {G}_{m} = Ø for l \neq m \\ {{⋃}^{M}}_{m = 0} {G}_{m} = \{ 1 , … , N \}$$

$${\sum }_{m = 0}^{M} {s}_{m} = N$$

For each m=0, . . . , M, let bₘ(1), . . . , bₘ(sₘ) denote the specific passengers in group Gₘ.

For each permutation p(•) (i.e., each seating assignment), let J(p) denote the total value to the airline of the resulting seating assignment. The objective function J(p) may incorporate payments made to or received from passengers for switching seats including consideration of group preferences and assignments. J(p) might also be a function of the number of switches made, number of passenger preferences fulfilled, number of group preferences fulfilled, or other considerations as desired by the airline.

One general form for the objective function may be

$$J ( p ) = {\sum }_{i = 1}^{{s}_{0}} {a}_{0} ( {b}_{0} ( i ) , p ( {b}_{0} ( i ) ) ) + {\sum }_{m = 1}^{M} {a}_{m} ( \begin{matrix}{b}_{m} ( 1 ) , p ( {b}_{m} ( 1 ) ) ; … ; \\ {b}_{m} ( {s}_{m} ) , p ( {b}_{m} ( {s}_{m} ) )\end{matrix} )$$

The aₘ(•) may represent the value to the airline for assigning specific passengers to specific seats. The aₘ(•) may be, but need not be, set in accordance with the trade values. For example, in some cases, the aₘ(•) may be set to reflect the actual payments made to or received from passengers, but in other cases they may reflect perceived benefits to the airline which may or may not coincide with monetary payments.

For a₀(•) the value depends on the individual passenger and the seat to which he is assigned. For example, for the permutation p, passenger 2 is assigned to seat p(2). Suppose this passenger is traveling alone and is willing to pay $25 to be moved to seat p(2). Then we can set a₀(2,p(2))=25. If passenger 5 is traveling alone and is willing to move to seat p(5) if she is paid $10, then we can set a₀(5,p(5))=−10. If passenger 17 is willing to move to seat p(17) for recognition on a website, then we might set a₀(17,p(17))=0 to reflect minimal (or no) cost to the airline, or we might set a₀(17,p(17))=1 to reflect a small benefit to the airline for making a switch.

For m=1, . . . , M, the aₘ(•) can take into account combined assignments and preferences of the passengers in group m. For example, suppose group 1 has three passengers, namely passengers 7, 10, 11, and that by assigning these passengers to seats p(7), p(10), p(11), respectively, the group is willing to pay $50. Then we can set a₁(7,p(7); 10,p(10); 11,p(11))=50. Suppose that group 2 has two passengers, namely passengers 3 and 9. If these passengers are willing to move to seats p(3) and p(9), respectively in exchange for 1000 airline miles, we may set a₂(3,p(3);9,p(9))=−20 to reflect the cost to the airline for giving 1000 airline miles.

The flexibility in setting the aₘ(•) allows the revenue to be different for every choice of seating assignment depending on individual and group preferences. When the aₘ(•) represent revenue to the airline, the objective criterion above represents the total revenue to the airline. Alternatively, aₘ(•) could be chosen in a way to maximize the number of switches which may be useful if revenue is less important to the airline than accommodating customer requests.

For passengers who are preassigned to a seat and are unwilling to move, the aₘ(•) can be chosen to accommodate this, by setting the value of the current seat assignment to 0 and the value of all other seats to a sufficiently large negative quantity (for example, a negative number with magnitude larger than the sum of all the positive aₘ(•)). Or, if there are only certain seats to which a passenger is unwilling to move or if a group is unwilling to move to a certain set of seats, then only these corresponding aₘ(•) may set to the sufficiently large negative value.

Any of a number of algorithms may be used by processor 130 to find a suitable assignment (permutation p) that maximizes or finds a sufficiently large value of J(p). In one embodiment, an approach is to consider all possible permutations and for each permutation compute the corresponding value of the objective function, and then select the permutation that gives the largest value for the objective function.

Another possibility is to reduce the number of permutations under consideration or to search some subset of permutations either before the search starts or as it proceeds. For example, depending on the preference restrictions placed by individual passengers or groups of passengers, it may be possible to reduce the number of seating assignments under consideration before or during evaluation of various assignments. In particular, if some seating assignments are not acceptable to individuals or groups then any permutation containing this assignment need not be considered. Similarly, if a group is assigned to a set of seats but is indifferent as to which passenger in the group is assigned to which specific seat in the set, then a number of assignments may have the same value and exploiting this may help in the optimization.

If the number of passengers is less than the number of seats, it may be preferable not to introduce ghost passengers. In this case, instead of considering permutations of the integers {1, . . . , N}, we might let p denote a one-to-one mapping from the integers {1, . . . , K} to the integers {1, . . . , N}. In this case, for each passenger i=K, p(i) denotes the seat to which passenger i is assigned. For K<N, the number of such mappings may be less than the number of permutations of the integers {1, . . . , N}, thereby reducing the number of seating assignments to be searched.

In another embodiment, it may be possible to search the set of permutations in a structured and possibly adaptive way. For example, branch and bound or other techniques may be used to efficiently search through permutations. As an illustration, if a partial assignment results in a contribution to the objective function J(p) such that no completion of the assignment can produce a sufficiently large value of J(p) then no assignments that involve this partial assignment need to be considered. This may improve the search for a good or optimal assignment.

In yet another embodiment, optimization of the objective function J(p) may be viewed as a special case of certain nonlinear assignment problems. For example, J(p) may be viewed as a special case of p-adic assignment problems where p denotes the size of the largest group. In this case, algorithms for these problems may be used to find good permutations. In particular, if the largest group is of size 2 (or if the group size is restricted to be no more than 2), then the optimization problem may be viewed as a special case of a quadratic assignment problem. If the largest group is of size 4 (or if the group size is restricted to be no more than 4), then the optimization problem may be viewed as a special case of a bi-quadratic assignment problem.

The structure of the objective function J(p) may also be used to design effective algorithms. For example, the objective function is a sum of distinct terms where each term is a function of a distinct group. Because the groups are disjoint, each passenger appears in exactly one of the terms of J(p).

It may be possible to find a good assignment without explicitly evaluating the objective function for each of a collection of permutations. For example, if all passengers are traveling individually so that all passengers belong to Gₒ then optimizing J(p) may be cast as a linear programming problem and methods from linear programming can be used to find an optimal solution.

The terms “optimization,” “optimize,” and other variants as used herein are not limited to the global maximum of a parameter but also include sufficiently good outcomes, e.g., where a parameter exceeds a predetermined criterion or threshold.

The systems and methods described above may be modified in a number of ways. For example, different priorities or weights could be assigned to passengers' seat reassignment requests based on who they are (e.g., elite frequent flyers, VIPs), or what they paid for their ticket (e.g., full fare vs. supersaver). Likewise, an airline could decide to give higher priority to families' requests to sit together, compared to requests by individuals to get a particular kind of seat. In these cases, the objective function J(p) could be modified to reflect these priorities or weights, e.g., by weighting the aₘ(•) appropriately.

As another possibility, passengers may be assigned or reassigned to seats based on seating preferences that relate to the seat assignments of other passengers. For example, one passenger might have a preassigned seat with a seating preference that includes profiles of people the passenger would like to sit with (e.g., co-workers from his company). Based on the seating preference information provided by this passenger and other passengers on the flight, the system may automatically identify certain passengers and assign or reassign one or more of them to seats that are together, apart, or are otherwise related, or notify them of a potential group that they may be seated with. Thus, the system may automatically link passengers based on their seating preferences, and assign or reassign their seats using the joint seating preferences.

Another possible modification is standing reassignment requests. A business traveler, for example, might have a profile with an airline specifying that he prefers aisle seats. The profile could also specify that a reassignment request for an aisle seat automatically should be submitted on his behalf on any flight on which he is preassigned to, say, a non-aisle seat. This standing reassignment request could include additional specificity in accordance with the above disclosure, such as which rows on the plane are acceptable or could also specify the passenger's desire to sit with others from his company, from other companies of interest to him, from a particular professional field, or based on other passenger attributes. Likewise, a family or other group of passengers could have a standing profile that specifies that a reassignment request should be submitted anytime their preassigned seats are not together, along with any additional criteria the new seats should satisfy. If a standing request is fulfilled, a credit card (or other form of payment) that is on file for the passenger(s) could be charged automatically.

Furthermore, the systems and methods described above may be applied to a variety of contexts other than switching seats on an airline flight. For example, the systems and methods may be applied to seat swaps that involve different flights or even different airlines. For example, a businesswoman who has a seat on a 5 pm flight may prefer a seat on a 7 pm flight, while a businessman may have and want the opposite. The teachings of the present disclosure could be used to implement systems and methods that permit these two passengers to switch seats (and flights) even if both flights are full. In this case, the desired flight number could be specified as a seat attribute in the reassignment request. Likewise, where flights on different airlines are involved, the name of the desired airline and flight number could be specified as seat attributes. In this case, various parts of system 10 might be implemented by multiple airlines (e.g., multiple databases instead of one database 120) and/or by a third party (e.g., processor 130 could be operated by a third party).

The systems and methods described above also may be applied to a variety of contexts other than airline seating. Seats on trains and other common carriers are some examples. Sporting events, concerts, shows, and other entertainment events are other examples. As in the context of airline seating, in these other contexts a suitable user interface would be used by ticketholders to specify a desire or willingness to switch seats and the conditions, if any, for switching, and a processor would be used to run an algorithm to reassign ticketholders to new seats. Ticketholders would then be notified of their new seats, and may be prompted to print new tickets reflecting the new seats, or may be sent new tickets by mail or electronically.

Although the teachings of the present disclosure are applicable to any venue offering seating arrangements to its customers, it has particular applicability to the airline industry due to the historically based ticketing policies of the airline industry. For example, the airline industry sometimes faces criticism for not providing a satisfactory “customer experience”. Some airlines shift prices and offer different prices for the same seat based on factors that are not always transparent to the customer. As such, it is sometimes common for passengers in adjacent seats to have paid very different prices for their respective seats. Likewise, airlines sometimes increase fares as the flight time gets closer such that a last minute flyer pays a much higher price than other passengers. However, the last minute passenger will typically have a less desirable seat than those passengers that booked earlier at lower prices. The present disclosure may ameliorate some of the effects of the airlines' pricing by enabling a last minute flyer, who may be willing to pay more, to swap his seat for a more desirable seat. Use of the present disclosure may assist an airline in encouraging passengers to book early to secure the most desirable seats, which can be traded later for value, thus reducing the passengers' total expense for the flight. An additional benefit to the airline and its customers is that the collection and analysis of information related to seat swapping, such as trade values for various seating preferences, may afford the airline industry the ability to modify their ticketing procedures to take into account their customers' preferences.

Due to security regulations and constraints, the airline may need to approve seat swaps. However, the airline may enter into relationships with third party providers to allow access to airline passenger and seating information in order to implement the present disclosure.

It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims. Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine-readable storage substrate, a memory device, a composition of matter affecting a machine-readable propagated signal, or a combination of one or more of them.

The term “processor” encompasses all apparatus, devices, and machines for processing data, including by way of example a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Those skilled in the art will appreciate that the present invention can be practiced by other than the described embodiments, which are presented for the purposes of illustration and not of limitation, and the present invention is limited only by the claims which follow.

What is claimed:

1. A method for reassigning seats for airline passengers who have preassigned seats on a flight, the method comprising:
providing a memory containing information identifying a plurality of passengers and their preassigned seats, and seat attributes for the flight;
providing a user interface for displaying information regarding the preassigned seats;
receiving via the user interface seat reassignment requests from the plurality of passengers, the requests including at least one group request that includes a seating preference and a trade value for a group of two or more passengers;
storing in the memory the seat reassignment requests;
accessing from the memory information regarding the plurality of passengers, preassigned seats, seat attributes, and seat reassignment requests;
using a processor to compute a configuration of reassigned seats, wherein the computation jointly uses a group reassignment request and at least one other reassignment request;
charging or compensating the plurality of passengers in accordance with the reassigned seats and trade values; and
informing the plurality of passengers of the reassigned seats.

2. The method of claim 1 wherein the seating preference for the group includes at least one of type, class of service, relative location in a row, row or rows on the plane, and acceptable seating configurations for the group.

3. The method of claim 1 wherein the trade value reflects compensation to be received for giving up a preassigned seat.

4. The method of claim 1 wherein the trade value includes at least one of cash, a cash equivalent, airline miles, rewards points, or food or drink vouchers.

5. The method of claim 1 wherein the step of using a processor to compute is performed at a predetermined time relative to the flight's scheduled departure time.

6. The method of claim 1 wherein the step of using a processor to compute is performed a plurality of times prior to the flight's departure.

7. The method of claim 1 wherein the processor computes a configuration of reassigned seats using an optimization criterion.

8. The method of claim 1 wherein the group includes at least two passengers in different airline records.

9. The method of claim 1 wherein a first passenger must approve a seat reassignment request made by a second passenger.

10. The method of claim 1 wherein the amount paid or received by one or more of the passengers in the group depends on the reassigned configuration.

11. The method of claim 1 wherein the amount paid or received by one or more of the passengers in the group depends on at least one of the preassigned and reassigned seats.

12. A method for facilitating seat reassignment for airline passengers who have preassigned seats on a flight, the method comprising:
accessing information relating to the preassigned seats for a plurality of airline passengers;
receiving via a user interface seat reassignment requests for the flight for the plurality of the passengers, the requests including at least one group request that includes a seating preference and trade value for a group of two or more passengers; and
storing the requests in a memory.

13. The method of claim 12 wherein the group includes at least two passengers in different airline records.

14. The method of claim 12 wherein one or more of the reassignment requests is received via a display interface made available to the plurality of passengers.

15. The method of claim 12 wherein the trade value can be selected by the group of passengers.

16. A method for reassigning seats for airline passengers who have been preassigned seats on a flight, the method comprising:
accessing information about seat reassignment requests that have been made by a plurality of passengers, the reassignment requests including at least one group reassignment request that includes a seating preference and trade value for a group of two or more passengers; and
using a processor to compute a reassigned seating configuration for the plurality of passengers, wherein the computation jointly uses a group reassignment request and at least one other reassignment request.

17. The method of claim 16 wherein the processor optimizes the reassigned seating configuration according to at least one predetermined criterion.

18. The method of claim 16 wherein one or more of the reassignment requests is received via a display interface made available to the plurality of passengers.

19. The method of claim 16 wherein the trade value can be selected by the group of passengers.

20. The method of claim 16 wherein the accessing and using steps are performed by an entity other than an airline and further including the step of informing the airline of the reassigned seating configuration.

21. The method of claim 16 wherein the processor weights at least two requests differently.

22. A method for reassigning a seat for an airline passenger who has been preassigned to a seat on a flight, the method comprising:
receiving from the passenger a seat reassignment request for the flight, the request comprising a seat attribute and a trade value;
receiving from the passenger compensation that is based on the trade value;
storing the request; and
using a processor, one or more times after the passenger has been preassigned, to access and attempt to fulfill the request.

23. The method of claim 22, wherein the compensation is equal to the trade value.

24. A method for reassigning seats for airline passengers who have preassigned seats on a flight, the method comprising:
accessing information relating to the preassigned seats for a plurality of airline passengers, wherein each preassigned seat is associated with an airline record;
receiving via a user interface a seat reassignment request for the flight, wherein the seat reassignment request is for at least two passengers having preassigned seats associated with at least two separate airline records; and
using a processor to compute a reassigned seating configuration for the at least two separate airline records.

25. A method for assigning a seat for an airline passenger ticketed for a flight, the method comprising:
accessing information relating to a seating preference for a first passenger having a preassigned seat including a first airline record;
automatically identifying a second passenger having a second airline record different than the first airliner record; and having a seating preference, wherein the automatic identification is based on the joint seating preferences of the two passengers; and
using a processor to assign a seat to the second passenger based on the joint seating preferences.
